(19) United States
(12) Patent Application Publication
(10) Pub. No.: US 2003/0130128 A1
(43) Pub. Date: Jul. 10, 2003

(54) Method of fabricating fine high temperature superconducting composites

(76) Inventor: Z. Han, Beijing (CN)

Correspondence Address: OPPENHEIMER WOLFF & DONNELLY, P. O. BOX 10356, PALO ALTO, CA, 94303, US

(21) Appl. No.: 10/209,492

(22) Filed: Jul. 30, 2002

(30) Foreign Application Priority Data
Aug. 8, 2001 (CN) 01123875.5

(51) Int. Cl. H01B 1/00; C11D 1/00

(52) U.S. Cl. 505/100

(57) ABSTRACT

A superconducting composite is fabricated by coating a wire or tape substrate with fine superconducting precursor powders followed by a sintering operation. A superconductor may also be prepared by further rolling. Several superconducting composites may be twisted together to obtain a multi-filamentary wire and sheathed by a silver foil or tube, at least partly open along the length.

### FIELD OF THE INVENTION

The present invention relates to superconducting composites. More particularly, it relates to a method of fabricating fine high temperature superconducting composites, by which those kinds of composites less than 0.5 mm in diameter or 0.3 MMZ in cross-sectional area with improved electrical and mechanical properties can be prepared.

### BACKGROUND OF THE INVENTION

The flexibility of high temperature superconducting composites will be improved if their cross-sectional areas are decreased, i.e., fine high temperature superconducting composites are prepared. Superconducting composites are usually bent for practical high-current applications, so their flexibility is a key factor in realizing the application potential of high temperature superconductors. According to general properties of superconducting materials, the maximum critical current density may be obtained when the superconducting composites are of rectilinear shape. When the composites are bent, their critical current density will be decreased with a small bending radius leading to more reduction in the critical current density. Therefore, a large critical bending strain, allowing a small bending radius, of superconducting composites is usually required in order to decrease the reduction of their current density as much as possible. The bending strain is equal to h/D according to deformation theory (Z.Han: MT-15, Beijing, October 20-24, 1997), where h and D are the thickness and bending diameter of a superconducting composite respectively. A critical bending strain, which has been suggested to be about 0.2%, is usually defined as the strain that results in 5% degradation of its critical current. When the bending strain exceeds the critical value of the material, the current-carrying capability will decrease significantly. A thinner superconducting composite will therefore lead to smaller bending strain under the condition of constant D or alternatively allow a smaller bending diameter under a certain bending strain, resulting in bending more easily. Furthermore, finer wires are helpful to decrease the alternating-current transport losses. Wesche R. et al. (Cryogenics, 34(10) 805-811, 1994) reported that the critical current density of a superconducting wire increases with the reduction of its diameter. In summary, the preparation of fine high temperature superconducting composites will contribute to improved electrical and mechanical properties.

Since most superconductors are brittle, and their strength is very low, it is very difficult to prepare fine and long high temperature superconducting composites with good performance.

Up to now, several attempts have been made for fabrication of fine and long superconductor composites.

Yamamoto, et al. in U.S. Pat. No. 5,100,865 disclose that powders of metal oxides are packed into a stainless steel or nickel alloy tube, then the packed tube is drawn to a desired size, and sintered in air, wherein the tube is removed prior to the final step of sintering. Since the high temperature superconducting powders are generally brittle, it is very hard to prepare fine and long superconducting wires by this process.

Another method for making superconducting wires is described by Geballe et al. in U.S. Pat. No. 5,070,071. The first step is to form a Bi—Sr—Ca—Cu—O superconducting solid by taking mixed powders of metal oxides, followed by grinding and pressing, and finally sintering at a temperature in the range of 750.degree C. to 800.degree. C. for 10-20 hours. Next, the solid is melted and a fine noble metal wire is drawn through this melt at the rate of 25 millimeters per hour, and the superconducting wire is obtained by cooling the coated wire. However, using this process it takes too much time to prepare a long superconducting wire.

Preparation of superconducting wires by the electrophoretic deposition technique is investigated by L. D. Woolf et al., (Applied physic letters, 58(5), 534-536, 1991), Nobuyuki Koura et al., (Physica C, 200, 50-54, 1992), Sun-li Huang et al., (Supercond. Sci. Technol., 8, 32-34, 1995) and M. Hechtl et al. (Supercond. Sci. Technol., 11, 520-522, 1998). For example, Sun-li Huang reported that the superconducting wires can be obtained by depositing 60 μm thick superconducting layers on both sides of 125 μm thick silver tapes, followed by a heat treatment. The tape can be bent to a radius of 5 mm, and its transport critical current density is up to 17000 A/cm^{z} at 77K and self field. Since a large amount of solvent is added into the solution during the deposition, it is difficult to completely remove the solvent. Hence, many voids may be generated in the obtained superconducting wire, reducing the electrical properties.

Onishi et al. in U.S. Pat. No. 5,229,357 reported melting homogeneously metal oxides capable of being transformed into a glass and then into a superconductor ceramic at 1150±100.degree.C., quenching the melt on cold metal sheet to form a preform of the glass, and then drawing this preform into long and flexible thin tapes maintaining the amorphous state of the glass. These thin tapes are heat treated at 420-430.degree.C., then rolled into 40-60 μm thick tapes to optimize the final grain orientation. Superconducting wires are finally obtained through further heat treatment and recrystallization of the tapes at 800-870.degree.C. The disadvantage of this process is that Pb in metal oxides may vaporize during the higher temperature treatment. Furthermore, it is very difficult to prepare long wires by this process.

Currently, the most widely used method is the powder-in-tube (PIT) process in which a metal tube (such as silver alloy) is filled with superconducting precursor powders in proper stoichiometry. The filled tube is then deformed into the required shape (wires or tapes) by extruding, drawing, rolling, etc. A number of filled containers (filaments) can be combined and surrounded by a matrix of another metal to form a multi-filamentary article. Finally, the material is subjected to one or more deformation and phase conversion heat treatment cycles that together form the desired oxide superconductor and helps the oxide superconducting grains align and grow to form the textured superconductor article. The main advantage of this technique is that it can be used to fabricate superconducting wires with high critical current density, but it is very difficult to prepare fine and long superconducting wire with less than 0.5 mm diameter or 0.3 mm′ rectangular cross-sectional area due to the following three main reasons:

(1) The deformation is very difficult. A high temperature superconducting wire, especially one based on bismuth, becomes very brittle after sintering, and its sheath is usually made of silver or silver alloy with only low strength. Its superconductor continuity is usually damaged during deformation, thereby impairing its mechanical and electrical properties. For this reason, the long wire usually has a minimum thickness.

(2) The size of superconductor powders limits the final wire diameter. The ideal powder size is less than 1.0 μm. However, the current available particle size is usually of several microns in magnitude, so it is difficult to prepare fine wires with such powders.

(3) The silver-sheathed tube confines the superconducting precursor powder from the surrounding atmosphere during heat treatments, preventing gas release, leading to bubbling problems.

A modified PIT process was provided by H. B. Liu et al in “Bi-2212/Ag tapes melt-grown under an elevated magnetic field(0-10T)”(Physica, C316, 234-238, 1999) and Dorris et al. in U.S. Pat. No. 5,866,515. According to H. B. Liu's report, single-filamentary superconductor wire prepared by the PIT process was firstly sintered in air under a 10 T magnetic field perpendicular to the wire surface, and heat treated at 840.degree.C. for 48 hours, leading to a well textured structure and high transport critical current density. Dorris et al. provided that a fine silver or silver alloy wire was coated with superconductor powders by a sputtering, electrophoresis or spraying method, then packed into a tube and obtained a desired superconductor wire after further treatment. These two processes are able to optimize the grain orientation, improve the interface area and superconductor properties between silver and the superconductor core. As a result, conductivity is enhanced relative to prior superconductor wires. However, the above two methods still possess the same disadvantages as the PIT process.

A dip-coating-then-stacking (DIS) process was developed by Y. S. Sung et al. (Physica C 331, 171-177, 2000), which is simpler and easier to perform than the PIT process. In the DIS process, superconducting tapes were prepared by stacking several layers of single side dip-coated Ag strips then wrapping them with Ag foil. After burning at 500.degree.C. to remove organic materials, the tape samples were rolled to increase the packing density of the oxide core, and heat-treated twice at 838.degree.C. in air with an intermediate pressing. Though the interface obtained by the above process between the oxide core and silver was continuous, there are still problems with surface flatness (often referred to as “sausaging”).

### SUMMARY OF THE INVENTION

It is a general object of the invention to provide a method of fabricating fine superconductor composites having improved electrical and mechanical properties.

The invention provides a method for fabricating a superconductor from an aggregate of wires or tapes coated with superconductor powders. A superconductor composite is obtained by homogeneously coating the wire or tape substrates with a dispersion of fine superconductor precursor powders, and followed by a sintering operation. Superconducting composites of desired size may be obtained by controlled rolling, and several superconducting composites may be twisted together to obtain a multi-filamentary wire and sheathed with a tube containing one or more openings, or a hatched silver foil. Homogeneous high temperature superconducting composites of less than 0.5 mm in diameter or 0.3 mm² in cross-sectional area which possess good electrical and mechanical properties are easily prepared by above process. Single- and multi-filamentary high temperature superconducting composites may be prepared by this invention.

This invention is composed of the following steps: (1) To homogeneously mix a paint containing superconducting precursor powders; (2) To clean the tape or wire substrate; (3) To coat homogeneously the tape or wire with the paint containing superconducting precursor powders; (4) To heat treat the tape or wire at a lower temperature in order to remove the solvent in the paint layer, and roll the tape or wire into a longer wire or tape and to coil them; (5) To heat treat the tape or wire at a higher temperature; (6) To coat the tape or wire with another protective layer if necessary.

In addition, the obtained tape or wire may also be deformed or coiled before or after the heat treatment at a higher temperature.

The precursor powders in the present invention may be a variety of superconducting powders, such as bismuth based superconducting precursor powder. Although the size of superconducting precursor powder particles may vary, less than 1.0 μm is recommended. The material of the tape or wire substrates may be that of any oxidation resistant metal, alloy or other flexible material capable of adhering to metal oxides, such as silver, silver alloy or nickel alloy. It may also be composed of nonmetallic material and buffer layer, such as SiO₂ glass fiber and oxide buffer layer. Other layer-covering methods may be used instead of coating, such as sputtering, electrophoresis, spraying etc in which case the low temperature annealing may or may not be required, and the coating thickness may be different. The wire or tape structure may be one of the following three kinds: (1) One wire coated with superconducting powders; (2) more than one wires coated with superconducting powders and twisted together; (3) one or more wires twisted together, inserted into a silver or silver alloy tube, arranged in axial or near-axial alignment with the silver sheath and with the coatings on adjacent superconducting wires being contiguous. The silver sheath is at least partly open along its length, and may be made from an open seam tube directly, or from a seamless tube with some pores made in the tube, or from a wrapped foil containing one or more slits, in each case allowing the superconducting materials to connect with the surrounding atmosphere. The solvent added into mixed powders may volatize from the wires through one or more openings during the sintering process at a low temperature. If it is necessary for the wire to be rolled, the rolling stage should be after the lower temperature sintering or after certain phase conversion in the wires. The fine wire can be prepared by a wind-and-react process (W&R process), allowing the use of a smaller coiling radius. In the conventional process, the superconducting wires are prepared by the react-and-wind process (R&W process), which can only be used up to an effective critical bending strain of about 0.2%. The current-carrying capability of wires will decrease significantly if the bending strain is beyond this critical value. However, if the W&R process is used, the bending radius of superconducting wires may be very small. Since the fine wire has low strength and can not withstand many deformation and phase conversion heat treatment cycles, a single step heat treatment process during the whole wire fabrication process is used by means of a special method, resulting in a wire with a critical current density of up to more than ⅔ of the maximum critical current density, and which possesses a smaller critical bending radius. This method together with the W&R process will allow production of wires having improved superconductor properties. The single step heat treatment process and W&R process can also be used in the PIT process to prepare fine wires.

This invention mainly has the following main advantages over other production methods: a simpler process, smaller diameter wire or smaller cross-sectional area tape and more wire/tape flexibility.

### BRIEF DESCRIPTION OF THE DRAWINGS

FIG. 1 is a schematic illustration of the process for production of a fine high temperature superconductor wire using the present invention.

FIG. 2 is a schematic illustration of a superconductor wire coated with superconductor powders (not drawn to scale).

FIG. 3 is a schematic illustration of a superconductor tape coated with superconductor powders(not drawn to scale).

### DETAILED DESCRIPTION OF THE PREFERRED EMBODIMENTS

The invention may be further understood from the following examples:

### EXAMPLE 1

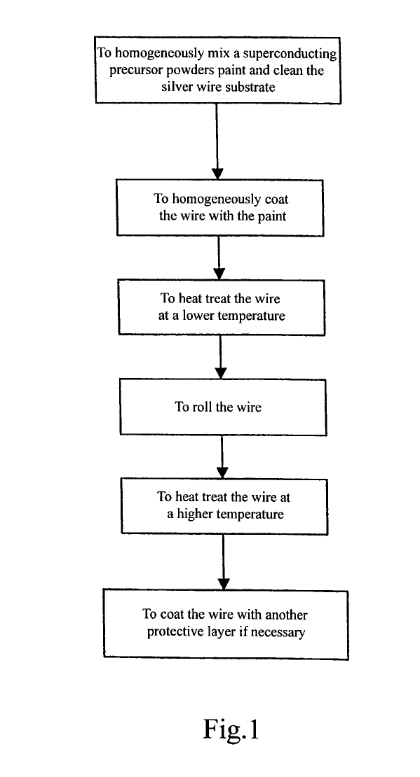

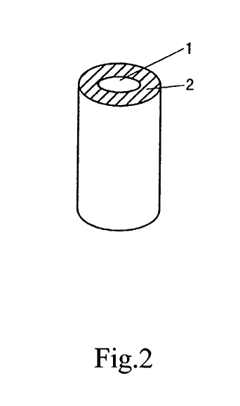

Following the process shown in FIG. 1, 100 g of 1.0 μm particle size Bi-2212 superconducting powder was combined with 200 g toluene. The mixture was homogenized, and then a clean silver wire with a diameter of 50 μm was directly coated with above mixture. The wire was heat treated in vacuum at 150.degree.C. for 24 hours and then annealed at more than 800.degree.C. to obtain a superconductor wire with a diameter of 60 μm as shown schematically in FIG. 2, where 1 is silver wire, 2 is superconductor.

### EXAMPLE 2

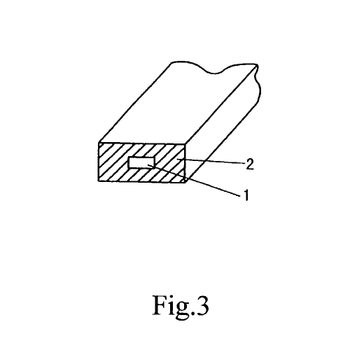

150 g 1.0 μm particle diameter Bi-2212 superconducting powder was combined with 300 g ethanol and 50 g PVB powder homogeneously, and then the mixture was directly applied to a silver alloy tape with cross-sectional dimension of 0.5×2 mm². The obtained tape was heat treated at 450.degree.C., and then rolled and annealed at more than 800.degree.C. so that to obtain a superconducting wire of 0.25 mm² in cross-sectional area, as shown schematically in FIG. 3, where 1 is silver wire, 2 is superconductor.

### EXAMPLE 3

150 g 1.0 μm particle diameter Bi-2223 superconducting powder was mixed with 300 g ethanol and 30 g PVB powder homogeneously, then a silver alloy tape of size 125 pm×2.7 mm×1000 mm in size was directly coated with the mixture. The obtained tape was heat treated in vacuum at 450.degree.C. for 8 hours, inserted into a silver alloy tube with an opening along its length, then rolled and coiled, and then finally annealed at 830.degree.C. to obtain a superconducting wire coil of 0.25 mm² in wire cross-sectional area.

### EXAMPLE 4

300 g organic solvent containing trichlorethylene, adhesive and dispersant was combined with 150 g 1.0 μm particle diameter superconductor powder consisting of mostly Bi-2212 and some Ca₂PbO₄. The mixture was homogenized. A silver alloy wire with a diameter of 50 μm was then directly coated with this mixture. 19 composite wires prepared by this process were twisted into a multi-filamentary wire, heat treated at 520.degree.C., and then rolled and coiled, and finally annealed at 830° C. to obtain a fine multi-filamentary superconductor coil.

### EXAMPLE 5

A silver alloy wire with a diameter of 0.5 mm was drawn by the PIT process, rolled into 1.5×0.1 mm² superconducting tape, further heat treated by a single step sintering process at more than 800.degree.C., and finally fabricated into a fine high temperature superconducting tape.

### EXAMPLE 6

A silver alloy wire with a diameter of 0.5 mm was drawn by the PIT process, and rolled into 1.5×0.1 mm² superconducting tape, wound into a superconductor coil with a diameter of 25 mm, and further heat treated by a single step sintering process above 830.degree.C. and finally fabricated into high temperature superconductor coil with a smaller inner diameter than possible using the conventional PIT process.

It will be apparent to those skilled in the art that the methods and advantages of the present invention are capable of being used in production of all multi-filamentary superconductor articles having a variety of compositions and morphologies. The invention is not intended to be limited by any of the particular descriptions and examples set forth above, which are set forth in the specification for purposes of illustration only. The scope and nature of the invention are set forth in the claims.

What is claimed is:

1. A method of manufacturing a fine high temperature superconductor wherein said superconducting composite is less than 0.5 mm in diameter or 0.3 mm² in cross-sectional area.

2. A method of making a fine high temperature superconductor according to claim 1 which comprises the steps: homogeneously coating a wire or tape substrates with a dispersion of fine superconductor precursor powders followed by a sintering process to obtain the desired superconducting composite.

3. A method of making a fine high temperature superconductor according to claim 1 or 2 wherein said precursor powders in the present invention may be a variety of superconducting precursor powders, such as bismuth based superconducting precursor powder or YBCO power, although the size of superconducting precursor powder particles may vary, less than 1.0 pm is recommended.

4. A method of making a fine high temperature superconductor according to claim 1 or 2 wherein said tape or wire substrate may be that of any oxidation resisted metal, alloy or other flexible material capable of adhering to metal oxides, such as silver, silver alloy or nickel alloy, it may also be composed of nonmetallic material and buffer layer, such as SiO₂ glass fiber and oxide buffer layer.

5. A method of making a fine high temperature superconductor according to claim 1 or 2 wherein several layer-covering methods may be used, such as coating, sputtering, electrophoresis, spraying etc, and the coating thickness thereof may be different.

6. A method of making a fine high temperature superconductor according to claim 1 or 2 wherein the wire or tape structure may be one of the following three kinds:
(1) one wire coated with superconducting powders,
(2) more than one wires coated with superconducting powders and twisted together,
(3) one or more wires twisted together, inserted into a silver or silver alloy tube, arranged in axial or near-axial alignment with the silver sheath and with the coatings on adjacent superconducting wires being contiguous, the silver sheath is at least partly open along its length, and may be made from open seam tube directly, or from a seamless tube with some pores made in the tube, or from a wrapped foil containing one or more slits, in each case allowing the superconducting materials to connect with the surrounding atmosphere.

7. A method of making a fine high temperature superconductor according to claim 1 or 2 wherein the solvent added into mixed powders may volatize from the wires through one or more openings during the sintering process at a low temperature, if it is necessary for the wire to be rolled, the rolling stage should be after the lower temperature sintering or after certain phase conversion in the wires.

8. A method of making a fine high temperature superconductor according to claim 1, wherein the fine wire may be prepared by the wind-and-react process (W&R process).

9. A method of making a fine high temperature superconductor according to claim 1 wherein the fine wire may be prepared through a single step heat treatment process.
